(19) United States
(12) Patent Application Publication
(10) Pub. No.: US 2025/0013996 A1
(43) Pub. Date: Jan. 9, 2025

(54) System and method of transferring cryptocurrency using traditional domain name

(71) Applicant: Tingkai Liu, Aurora, IL (US)

(72) Inventor: Tingkai Liu, Aurora, IL (US)

(21) Appl. No.: 18/346,811

(22) Filed: Jul. 4, 2023

(51) Int. Cl. G06Q 20/06

(52) U.S. Cl. CPC G06Q 20/0655

(57) ABSTRACT

The present disclosure provides a system and method of transferring cryptocurrency using traditional domain names. The system includes a server of or on behalf of a receiver, a sender's device, and a distributed ledger (DL) network. The server is configured to host a web page or an application with a URL containing a traditional domain name for resolution of at least a cryptocurrency address. The sender's device is configured to send cryptocurrency to said URL. Nodes of the DL network are configured to resolve said cryptocurrency address by visiting the URL and extract the cryptocurrency address, and then complete the transaction using the resolved address. The method includes steps to configure the system. After configuration users send cryptocurrencies to a URL, and nodes of said DL network resolve the cryptocurrency address, and then use the resolved address to complete the cryptocurrency transaction. The invention makes sending cryptocurrencies like Zelle® Pay.

### FIELD OF THE INVENTION

The invention pertains to the field of payment schemes. More particularly, the invention pertains to a computer-implemented system and method of transferring cryptocurrency using traditional domain name.

### BACKGROUND OF THE INVENTION

A cryptocurrency address is a unique identifier that is used to receive cryptocurrency or any other information on distributed ledgers. It is typically a long and complex string of characters used by distributed ledgers like blockchains to identify a receiving address. Like Internet Protocol (IP) address, it is not designed for human reading. It is stressful for cryptocurrency users when it comes to keying in a cryptocurrency address. Many of them might wonder whether they put a correct address even after validating multiple times and through copy/paste approach. They also worry if they put the right address to wrong crypto which will also lead to loss of the crypto. To resolve this problem, there have been past attempts to create blockchain domain name systems dedicated to map cryptocurrency addresses to human readable names in a decentralized way on blockchains. Such attempts seem plausible, but they create new problems. The decentralization and anonymity nature of blockchains allows anyone to purchase any domain names for any reason. This presents problems for companies with valuable brand names, and fuels scams of all types. For example, a scammer can easily create blockchain domains of companyA.eth, companyA.btc or any other names disguising themselves as the legitimate entity to scam Company A's customers. Therefore, there is a need in the art for a system and method of transferring cryptocurrency using traditional domain name which provides human readable addresses for cryptocurrency transactions and protect business by avoiding blockchain domain scams. A patent (U.S. Ser. No. 10,721,060) by Kaizer et al. tried to resolve the problem but used a complicated approach. The present invention leverages traditional domain name systems and provides a simple solution.

### SUMMARY OF THE INVENTION

The present disclosure provides a system and method of transferring cryptocurrency using traditional domain names. The system includes a server owned/controlled by or serving on behalf of a receiver, a sender's device, a distributed ledger (DL) network, and optionally a receiver's device. The server is configured to host a web page or an application with a URL containing traditional domain name for resolution of at least a cryptocurrency address. The sender's device is configured to send cryptocurrency to said URL. Nodes of the DL network are configured to resolve the cryptocurrency address by visiting the URL and extracting intended cryptocurrency address, optionally move the URL or part of it to transaction memo, and then complete the transaction using the resolved address. The receiver's device is configured to check the status of a transaction. The method includes a series of steps to configure the sender's device, the server and nodes of the DL network as specified in the disclosed system. After configuration users send cryptocurrencies to a URL, and nodes of the DL networks will resolve the cryptocurrency address by visiting the URL and extracting the intended address, and then use resolved cryptocurrency address to complete the transaction. The method may include additional steps to write URL or part of it in transaction memo, which may be used for account identification. The present invention allows users to send cryptocurrencies like Zelle® Pay through DL networks such as blockchains.

### BRIEF DESCRIPTION OF THE DRAWING

FIG. 1 is a system of transferring cryptocurrency using traditional domain name where a server and a distributed ledger network are configured to resolve cryptocurrency address(es).

FIG. 2 is a system of transferring cryptocurrency using traditional domain name where a server and a distributed ledger (DL) network are configured to resolve cryptocurrency address(es), and the DL network is further configured to write a transaction memo for account identification, and the server is further configured for a receiving party to credit cryptocurrency amount to its customer based on the transaction memo, and for customer(s) to log in and check balance.

FIG. 3 is a flowchart of a method of transferring cryptocurrency using traditional domain name which includes steps of configuring a server and a distributed ledger network for resolution of cryptocurrency address(es).

FIG. 4 is a flowchart of a method of transferring cryptocurrency using traditional domain name which includes steps of configuring a server and a distributed ledger network for resolution of cryptocurrency address(es), and also for identification of customer account(s) and crediting cryptocurrency to customer(s) which are highlighted in bold font.

### DETAILED DESCRIPTION OF THE INVENTION

### Glossary of Terms

Plurality means more than one.

Distributed ledger (DL) uses independent computers (referred to as nodes) to record, share and synchronize transactions in their respective electronic ledgers (instead of keeping data centralized as in a traditional ledger).

Distributed ledger technology (DLT) is the technological infrastructure and protocols that are used to implement distributed ledger.

Blockchain is one type of distributed ledger. It organizes data into blocks, which are chained together in an append-only mode.

Cryptocurrency or crypto is a digital or virtual currency that is secured by cryptography, which makes it nearly impossible to counterfeit or double-spend.

Cryptocurrency address is a unique identifier that is used to receive cryptocurrency or any other information on a distributed ledger. It can be an external account address that is controlled by anyone who has the private key, or a smart contract address that is controlled by code.

Domain Name System (DNS) is a hierarchical and distributed naming system for computers, services, and other resources in the Internet or other Internet Protocol (IP) networks. It is also referred to as traditional Domain Name System (tDNS) to distinguish it from blockchain Domain Name Systems.

Domain name (or simply domain) is a human friendly name that is mapped to a physical IP address on the Internet using the Domain Name System. It is referred to as traditional domain name to distinguish it from blockchain domain name.

Blockchain Domain Name System (bDNS) is a decentralized naming system on a blockchain designed to map a blockchain domain name to a cryptocurrency address.

Blockchain domain name is a human friendly name that is mapped to a cryptocurrency address on a blockchain network using a Blockchain Domain Name System.

Uniform Resource Locator (URL) is a reference to an internet resource that specifies its location on a computer network and a mechanism for retrieving it. URLs occur most commonly to reference web pages (HTTP/HTTPS) but are also used for file transfer (FTP), email (mailto), database access (JDBC), and other applications.

### Description

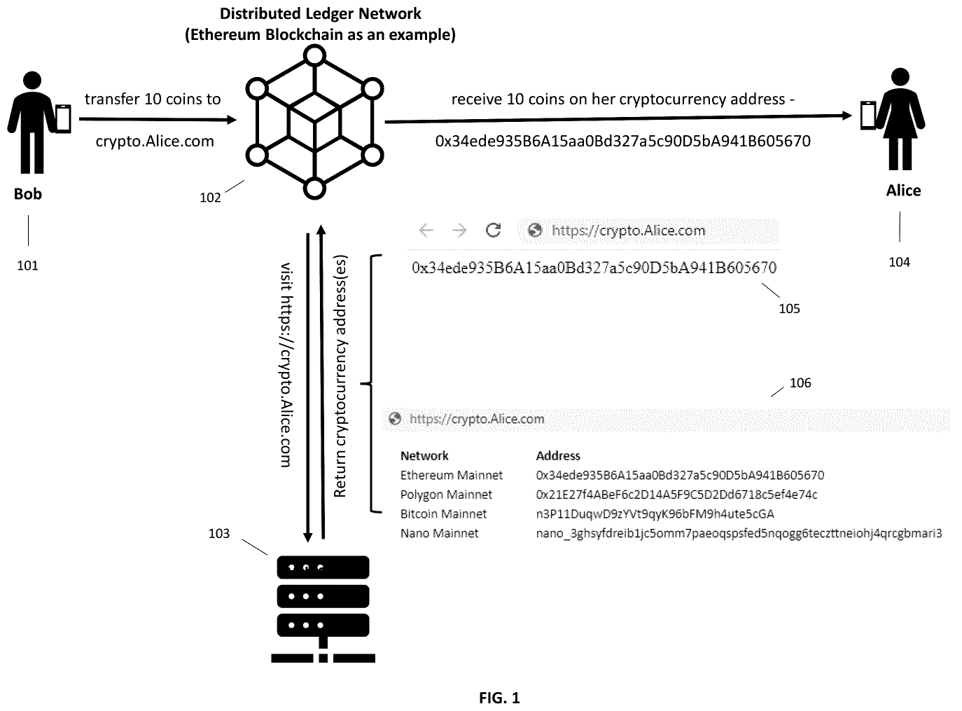

According to an embodiment of the present invention, a system of transferring cryptocurrency comprises at least a server owned by or controlled by or serving on behalf of a receiving party (103), at least a device of a sending party (101), a distributed ledger (DL) network containing a plurality of nodes (102), and optionally a device of the receiving party (104) as shown in FIG. 1.

The server (103) is configured to
to be identifiable by a traditional domain name;
host a web page or an application with a URL that contains said domain name where said URL may be just the domain name itself or a subdomain of said domain name or any other forms containing said domain name or its subdomain;
optionally enable secure protocols such as https; and
whenever said URL or part of it is visited, return data that may be used for resolution of at least a cryptocurrency address where said data may contain said cryptocurrency address directly (105), or may contain a plurality of records, each of which contains cryptocurrency address(es) and an attribute indicating corresponding DL network of the address and one of which contains said cryptocurrency address that is intended to be resolved (106) or may contain information guiding the resolution of said cryptocurrency address for an example of such information like “https://Alice.com/DLNetwork=Ethereum” which may be further used to resolve said cryptocurrency address.

The sending party's device (101) is configured to initialize a cryptocurrency transaction with a receiving address containing said URL. This does not need a special configuration other than standard procedure of sending cryptocurrencies. The difference is that the input box for receiving address(es) should allow URL containing domain names. Some client tools of DL networks enable error-checking mechanism for cryptocurrency address allowing only letters and numbers to be keyed in. This mechanism should be turned off for the disclosed system.

Nodes of the DL network (102) are configured to
visit the URL or part of it when a request of said cryptocurrency transaction is received;
retrieve the returned data of the visit;
resolve said cryptocurrency address of the URL utilizing returned data of the visit, for examples, through extracting said cryptocurrency address directly from the returned data, or through a more complex approach including steps of locating said cryptocurrency address first and then extracting it in cases that the returned data contains addresses of multiple DL networks or contents unrelated to cryptocurrency transfer, or through an approach guided by returned data;
optionally decline said transaction if visiting the URL returns any certificate warnings or errors or resolution of said cryptocurrency address fails;
optionally move the URL or part of it to transaction memo or encode the URL or part of it and then move it to transaction memo; and
complete the cryptocurrency transaction using the resolved cryptocurrency address.

The receiving party's device (104) is configured to explore the transaction record.

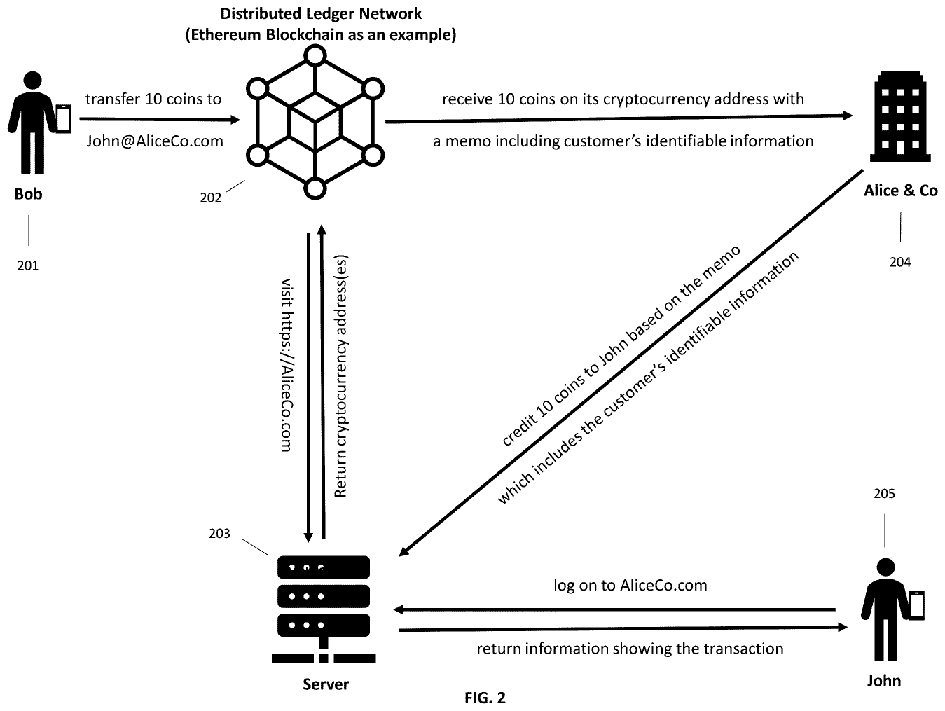

According to an embodiment of the present invention, the system of transferring cryptocurrency using traditional domain name may be further configured for a receiving party to receive cryptocurrency on behalf of its customers. FIG. 2 is a variant of FIG. 1. where the receiving party (204) is an entity that provides cryptocurrency service for customers (205).

The server (203) is further configured to
host a web page or an application with said URL that may be used for resolution of said cryptocurrency address and identification of at least a customer account, for an example of John@AliceCo.com or https://AliceCo.com/username=John where ‘AliceCo.com’ is used to resolve the cryptocurrency address and ‘John’ is used to identify the customer account (please note: AliceCo.com is can be used as a home page of Alice & Co as long as it includes the information required for the resolution of said cryptocurrency address);
credit cryptocurrency to said customer account based on the transaction memo when a transaction is completed with a memo indicating said customer account; and
have a user interface to allow customers to log on and check their cryptocurrency balance.

Nodes of the DL network (202) are further configured to
recognize the part of the URL that is intended for resolution of said cryptocurrency address and the part of it that is intended for identification of said customer account;
have a transaction memo that allows URL or part of it to be written in; and
move at least the account identification part to transaction memo;

The device of a customer (205) is configured to log on the server and check their cryptocurrency balance.

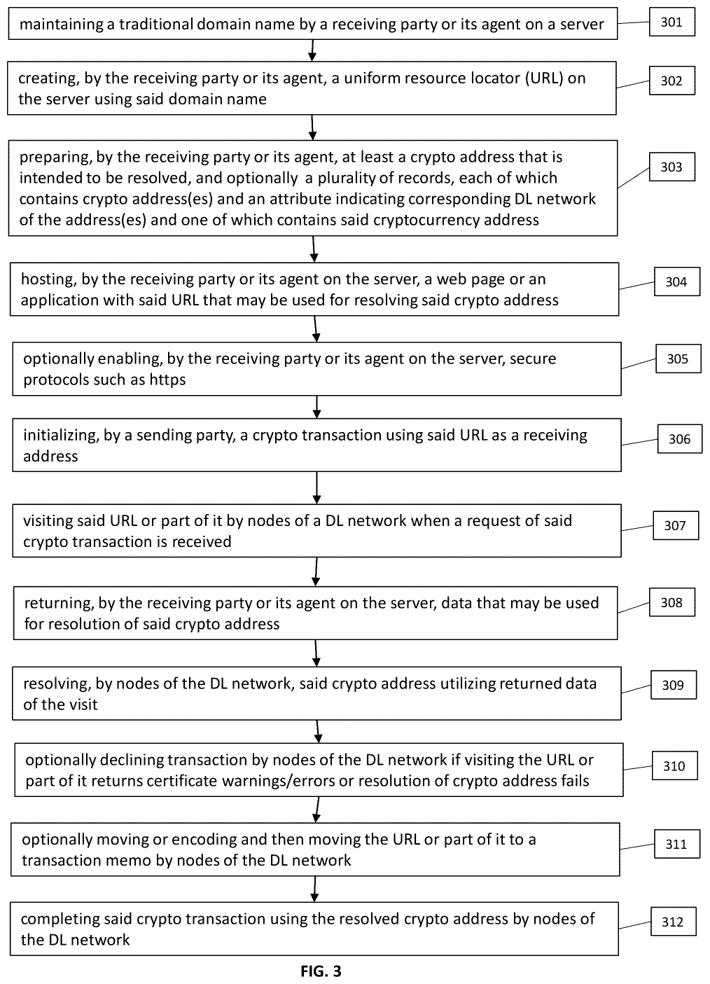

According to an embodiment of the present invention, a method of transferring cryptocurrency comprises steps of (FIG. 3)
maintaining a traditional domain name by a receiving party or its agent on a server (301);
creating, by the receiving party or its agent, a uniform resource locator (URL) on the server using said domain name where said URL may be just the domain name itself or a subdomain of said domain name or any other forms containing said domain name or its subdomain (302);
preparing, by the receiving party or its agent, at least a cryptocurrency address that is intended to be resolved, and optionally a plurality of records, each of which contains cryptocurrency address(es) and an attribute indicating corresponding DL network of the address(es) and one of which contains said cryptocurrency address (303);
hosting, by the receiving party or its agent on the server, a web page or an application with said URL that may be used for resolution of said cryptocurrency address (304);
optionally enabling, by the receiving party or its agent on the server, secure protocols such as https (305);
initializing, by a sending party, a cryptocurrency transaction using said URL as a receiving address (306);
visiting, by nodes of a DL network, said URL or part of it when a request of said cryptocurrency transaction is received (307);
returning, by the receiving party or its agent on the server, data that may be used for resolution of said cryptocurrency address where said data may contain said cryptocurrency address directly (105), or may contain a plurality of records, each of which contains cryptocurrency address(es) and an attribute indicating corresponding DL network of the address(es) and one of which contains said cryptocurrency address that is intended to be resolved (106) or may contain information guiding the resolution of cryptocurrency address (308);
resolving, by nodes of the DL network, said cryptocurrency address utilizing the returned data, for examples, through extracting said cryptocurrency address from the returned data, or through a more complex approach including steps of locating said cryptocurrency address first and then extracting it in cases that the returned data contains addresses of multiple DL networks or contents unrelated to cryptocurrency transfer, or through an approach guided by returned data (309);
optionally declining transaction by nodes of the DL network if visiting the URL or part of it returns any certificate warnings or errors or resolution of said cryptocurrency address fails (310);
optionally moving the URL or part of it to transaction memo or encoding the URL or part of it and then moving it to transaction memo by nodes of the DL network (311); and
completing, by nodes of the DL network, said cryptocurrency transaction using the resolved cryptocurrency address (312).

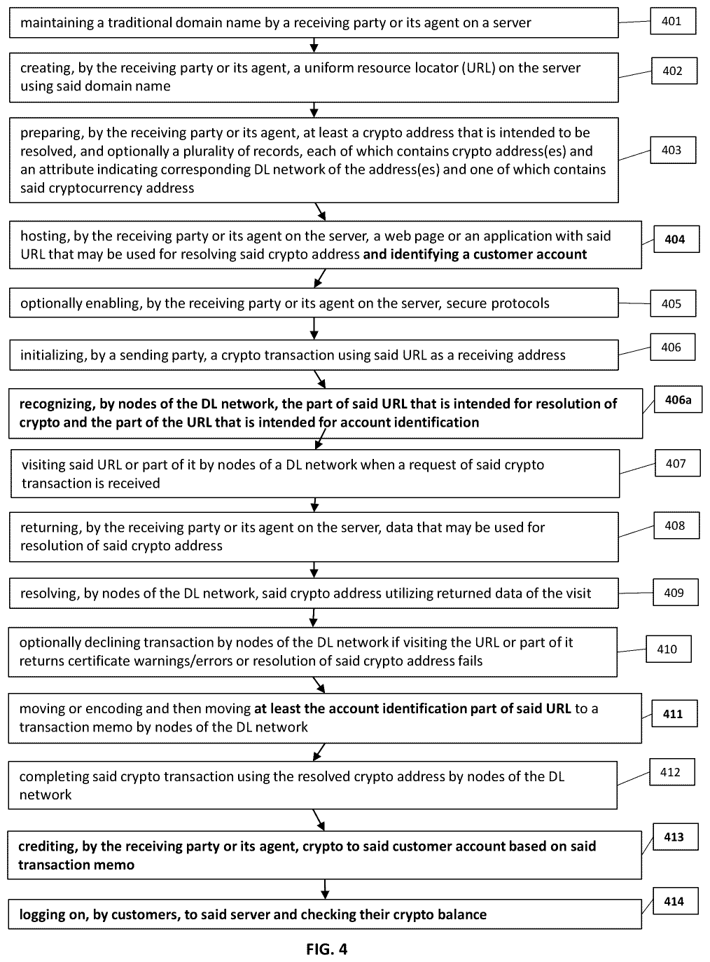

According to an embodiment of the present invention, the method may include additional steps for a receiving party or its agent to receive cryptocurrency on behalf of its customers. FIG. 4 is a variant of FIG. 3. The additional steps are highlighted in bold font in FIG. 4 and below:
hosting, by the receiving party or its agent on the server, a web page or an application with said URL that may be used for resolution of said cryptocurrency address and identification of a customer account (404);
recognizing, by nodes of the DL network, the part of said URL that is intended for resolution of said cryptocurrency address and the part of the URL that is intended for identification of said customer account (406a);
moving or encoding and then moving at least the account identification part of said URL to a transaction memo by nodes of the DL network (411);
crediting, by the receiving party or its agent, cryptocurrency to said customer account based on the transaction memo (413); and
logging on, by customers, to said server and checking their cryptocurrency balance (414).

### An Example of Use Cases

Alice & Co is a company proving cryptocurrency services. Currently customers are assigned a cryptocurrency (crypto) address for each cryptocurrency. The company maintains thousands of crypto addresses on behalf of its customers. To transfer crypto to Alice & Co, customers have to copy corresponding crypto address provided by the company and paste it to send-to box in a sending application, or use the sending application's scanning feature to screen the QR code of a crypto address provided by Alice & Co. Either way, customers are very stressful when it comes to key in a crypto address. First, they worry if the address is keyed in correctly. They check the human-unfriendly address multiple times. Second, they worry if they put the right address for the right crypto, because each crypto has a different address. If they put the right address to wrong crypto, they will suffer the loss.

By implementing the present invention, the problems will be resolved. Alice & Co does not need to maintain millions of crypto addresses for its customer. It just needs to maintain crypto addresses for itself, which will be just dozens of addresses. The company prepares a table with two columns: DL network and address. It then puts the table into its homepage but collapsed under a tab named Wallets. Alternative, it can create a Wallet link inside the homepage that point to a resource that contains said table. Anyone can see the addresses by visiting https://AliceCo.com and check the Wallet tab or link. Customers already have a unique username when they register an account with the company. Now customer can send crypto to a single address like John@AliceCo.com. Nodes of DL networks are configured to resolve the crypto address and move at least account identification part of the URL to transaction memo specified in the present invention. For an instance, John sends 2 bitcoins to John@AliceCo.com. Nodes of the newly configured bitcoin network will visit https://AliceCo.com first and locate the bitcoin address, and extract that address, and then use that address for the transaction. The nodes are also configured to move at least “John” or encoded “John” to transaction memo, which will be used for account identification by Alice & Co. Once the blockchain transaction is completed, Alice & Co will credit 2 bitcoins to John's account. John can then check the balance by log on the https://AliceCo.com. If John's friends want to transfer cryptos to John's account with Alice & Co, they can just simply send to the single address—John@AliceCo.com—for any kind of cryptos that Alice & Co serves. The DL networks will resolve the crypto addresses for Alice & Co and send them to the right address, and the DL networks will also write proper transaction memos based on which John will be credited. Once transactions are completed, Alice & Co will credit corresponding crypto amount to John's account and John can check the balance by logging on to his account. In such a way, crypto users feel ease when it comes to keying in the crypto addresses, and it's easy for them to remember as well.

Alice & Co developed a crypto wallet app named AWallet for its customers. The app creates crypto addresses or import existing addresses on user's device and the company doesn't store any private keys which are totally managed by the app on customers' devices. The wallet is designed for decentralized applications. To better serve its customer, Alice & Co can use the present invention. For each customer, the app will create a unique subdomain, for instance, John.AliceCo.com. Then the app will synchronize the data of DL network and customer's crypto addresses to the server of Alice & Co, but private keys are not uploaded. For the instance, John now has a web page with URL of John.AliceCo.com showing John's crypto addresses and corresponding DL networks. For anyone who wants to send crypto to John, they can just send to John.AliceCo.com. The DL networks will resolve the crypto address by visiting John.AliceCo.com which will return the information that is required for the resolution of crypto addresses.

What is claimed is:

1. A system of transferring cryptocurrency comprising
at least a server owned by or controlled by or serving on behalf of a receiving party that is configured to
be identifiable by a traditional domain name;
host a web page or an application with a uniform resource locator (URL) that contains said domain name and that may be used for resolution of at least a cryptocurrency address; and
return data that may be used for resolution of said cryptocurrency address when said URL or part of it is visited,
at least a device of a sending party that is configured to initialize a cryptocurrency transaction with a receiving address containing said URL, and
a distributed ledger (DL) network containing a plurality of nodes that are configured to
visit the URL or part of it when a request of said cryptocurrency transaction is received;
resolve said cryptocurrency address of the URL utilizing returned data of the visit; and
complete said cryptocurrency transaction using the resolved cryptocurrency address.

2. The server of claim 1 being further configured to
enable secure protocols such as https;
host the web page or application with said URL that may be used for resolution of said cryptocurrency address and identification of a customer account;
return data that may contain said cryptocurrency address directly, or may contain a plurality of records, each of which contains cryptocurrency address(es) and an attribute indicating corresponding DL network of the address(es) and one of which contains said cryptocurrency address that is intended to be resolved, or may contain information guiding the resolution of said cryptocurrency address;
credit cryptocurrency to said customer account based on the transaction memo when a transaction is completed with a memo indicating said customer account; and
have a user interface to allow customers to log on and check their cryptocurrency balance.

3. Nodes of the DL network of claim 1 being further configured to
recognize the part of said URL that is designed for resolution of said cryptocurrency address and the part of it that is designed for identification of said customer account;
resolve said cryptocurrency address through extracting said cryptocurrency address directly from the returned data, or through a more complex approach including steps of locating said cryptocurrency address first and then extracting it in case that the returned data contains addresses of multiple DL networks or contents unrelated to cryptocurrency transfer, or through an approach guided by said returned data in case that the returned data contains information guiding the resolution of said cryptocurrency address;
decline said transaction if visiting the URL returns any certificate warnings or errors or resolution of said cryptocurrency address fails; and
move or encode and then move the URL or part of it or the part of it that is designed for account identification to a transaction memo.

4. A method of transferring cryptocurrency comprising steps of
maintaining a traditional domain name by a receiving party or its agent on a server;
creating, by the receiving party or its agent on the server, a URL using said domain name;
preparing, by the receiving party or its agent, at least a cryptocurrency address that is intended to be resolved;
hosting, by the receiving party or its agent on the server, a web page or an application with said URL that may be used for resolution of said cryptocurrency address;
initializing, by a sending party, a cryptocurrency transaction using said URL as a receiving address;
visiting, by nodes of a DL network, said URL or part of it when a request of said transaction is received;
returning, by the receiving party or its agent on the server, data that may be used for resolution of said cryptocurrency address;
resolving, by nodes of the DL network, said cryptocurrency address utilizing the returned data; and
completing, by nodes of the DL network, said cryptocurrency transaction using the resolved cryptocurrency address.

5. The method of claim 4 further comprising steps of
enabling, by the receiving party or its agent on the server, secure protocols such as https;
hosting, by the receiving party or its agent on the server, a web page or an application with said URL that may be used for resolution of said cryptocurrency address and identification of a customer account;
returning, by the receiving party or its agent on the server, data that may contain said cryptocurrency address directly, or may contain a plurality of records, each of which contains cryptocurrency address(es) and an attribute indicating corresponding DL network of the address(es) and one of which contains said cryptocurrency address that is intended to be resolved, or may contain information guiding the resolution of said cryptocurrency address;
recognizing, by nodes of the DL network, the part of said URL that is designed for cryptocurrency address resolution and the part of the URL that is designed for account identification;
resolving, by nodes of the DL network, said cryptocurrency address through extracting said cryptocurrency address directly from the returned data, or through a more complex approach including steps of locating said cryptocurrency address first and then extracting it in case that the returned data contains addresses of multiple DL networks or contents unrelated to cryptocurrency transfer, or through an approach guided by said returned data in case that the returned data contains information guiding the resolution of said cryptocurrency address;
declining said transaction by nodes of the DL network if visiting the URL returns any certificate warnings or errors or resolution of said cryptocurrency address fails;
moving or encoding and then moving the URL or part of it or the part of it that is designed for account identification to a transaction memo by nodes of the DL network;
crediting, by the receiving party or its agent, cryptocurrency to said customer account based on said transaction memo; and
logging on, by customer(s), to the receiving party's server and checking their cryptocurrency balance.
